(19) United States
(12) Patent Application Publication
(10) Pub. No.: US 2004/0171469 A1
(43) Pub. Date: Sep. 2, 2004

(54) Polypropylene/cushioned envelope

(76) Inventors: Maurizio Brandolini, Milano (IT); Charles Kannakeril, North Caldwell, NJ (US)

Correspondence Address: CRYOVAC, INC., SEALED AIR CORP, P.O. BOX 464, DUNCAN, SC, 29334, US

(21) Appl. No.: 10/797,357

(22) Filed: Mar. 10, 2004

Related U.S. Application Data
(62) Division of application No. 10/175,787, filed on Jun. 20, 2002.

(51) Int. Cl. B31B 1/00

(52) U.S. Cl. 493/186; 428/194; 229/68.1

(57) ABSTRACT

An envelope includes a front wall having two lateral edges, a top edge, and a bottom edge; and a rear wall having two lateral edges, a top edge, and a bottom edge, the front and rear walls joined along their respective lateral and bottom edges; wherein the front and rear walls each have an outer ply including an outer layer including a propylene polymer or copolymer, polyamide or copolyamide, or polyester or copolyester, and an inner layer including an ethylene homopolymer or copolymer; and an inner ply including an inner and outer surface, including an air cellular or foamed material; the inner surface of the outer ply being adhered to the outer surface of the inner ply. A closure flap or other closure device, and one or more intermediate layers, can optionally be included in the envelope.

### FIELD OF THE INVENTION

The present invention relates to an envelope including an air cellular or foamed material, suitable for mailing documents or other items.

### BACKGROUND OF THE INVENTION

A wide variety of products, especially documents, books, and other items, including fragile items, are transported in various types of mailing envelopes generally called “mailers”.

One type of a commercial mailer is an envelope with a front and rear wall, sealed at its two lateral and bottom edges, with a flap integrally formed from and extending from the rear wall. The flap extends beyond the upper end of the front wall when the envelope is open. The flap includes on one side a pressure sensitive adhesive that is covered by a release tape. After the envelope is filled with an article to be mailed, the release tape is removed from the flap, and the flap is folded over and adhered to the exterior surface of the front wall, thus sealing the envelope.

The walls of this type of commercial envelope comprise a multilayer outer ply, and an air cellular material forming an inner ply. The air cellular material is typically a material such as BUBBLE WRAP ™ air cellular material sold by Sealed Air Corporation.

The outer ply is adhered to the inner ply.

In one commercial example, the outer ply is a polyethylene coated paper. In this example, the air cellular material forming the inner ply provides protection of the contents of the mailer by creating a cushioning effect. The paper of the outer ply offers good stiffness with moderate thickness; “writability” so that an address can be written on the outside surface of the mailer; a strong, aesthetic seal, owing to the relatively high resistance of the paper to heat; and rapid sealing of the mailer during production.

More recently, all plastic mailers have become more popular because of issues of recyclability; the need to have a material tougher than paper; and the need to have a waterproof mailer. These all plastic mailers typically have an outer ply that comprises an outer layer of a high density polyethylene (HDPE), and an inner layer comprising a low density polyethylene (LDPE). The outer layer thus forms the outermost layer of the envelope. The inner layer is in adhering contact with the air cellular material of the inner ply.

Although an improvement in some respects over the paper based mailers described above, the all plastic mailers nevertheless have some disadvantages. They have an outer ply with a melting point close to that of the air cellular inner ply. As a result, it is difficult to obtain a good seal during the production of the mailer. To overcome this, modifications to the manufacturing process, and extended seal times, are required. This adds significant cost to the production of this type of envelope, and consequently, the market success of the all plastic envelopes has been limited. Additionally, since polyethylene is inherently soft (low modulus) compared to paper, greater thicknesses are required to obtain comparable modulus values; this adds further to the cost of production.

The inventors have now found that an envelope can be made using a multilayer film laminated to an air cellular or foamed material, where the outer ply of the film comprises propylene polymer or copolymer, polyamide or copolyamide, or polyester or copolyester. The multilayer film offers a higher melt temperature, and a higher modulus, than the outer ply of the commercially available all-plastic mailer, thus allowing for faster production of the mailer. The resulting empty, finished mailer can also be processed more quickly by the user of the mailer, such as commercial large-scale mail distribution systems.

### SUMMARY OF THE INVENTION

In a first aspect, an envelope comprises a front wall having two lateral edges, a top edge, and a bottom edge; a rear wall having two lateral edges, a top edge, and a bottom edge, the front and rear walls joined along their respective lateral and bottom edges; the front and rear walls each comprising an outer ply comprising an outer layer comprising a polymer selected from the group consisting of propylene polymer or copolymer, polyamide or copolyamide, and polyester or copolyester; and an inner layer comprising ethylene homopolymer or copolymer, wherein the outer ply has an outer surface and an inner surface; and an inner ply having an inner surface and an outer surface, comprising an air cellular or foamed material; the inner surface of the outer ply being adhered to the outer surface of the inner ply.

In a second aspect, a method of making an envelope comprises providing a multilayer film web comprising an outer layer comprising a polymer selected from the group consisting of propylene polymer or copolymer, polyamide or copolyamide, and polyester or copolyester, and an inner layer comprising an ethylene homopolymer or copolymer; providing a second web comprising an air cellular or foamed material; advancing the multilayer film web and the second web between a heated roll and a second roll, such that the outer layer of the multilayer film web comes in contact with the heated roll, one surface of the second web comes in contact with the second roll, and the inner layer of the multilayer film web comes in contact with and adheres to the second web to form a laminate; cutting the laminate to form a first portion and a second portion, each portion having two lateral edges, a top edge, and a bottom edge; and sealing the first and second portions along their respective lateral edges and bottom edges to form the envelope.

In a third aspect, a method of making an envelope comprises providing a multilayer film web comprising an outer layer comprising a polymer selected from the group consisting of propylene polymer or copolymer, polyamide or copolyamide, and polyester or copolyester, and an inner layer comprising an ethylene homopolymer or copolymer; providing a second web comprising an air cellular or foamed material; advancing the multilayer film web and the second web between a heated roll and a second roll, such that the outer layer of the multilayer film web comes in contact with the heated roll, one surface of the second web comes in contact with the second roll, and the inner layer of the multilayer film web comes in contact with and adheres to the second web to form a laminate; folding the laminate to form a first portion and a second portion, each portion having two lateral edges; and sealing the first and second portions along their respective lateral edges to form the envelope.

### BRIEF DESCRIPTION OF THE DRAWINGS

A detailed description of preferred embodiments of the invention follows, with reference to the attached drawings, wherein:

FIG. 1 is a perspective view of an envelope with a closure flap in an open position;

FIG. 2 is a front plan view of the envelope of FIG. 1, with the closure flap in a closed position, and with a portion of the front wall of the envelope partially cut away to disclose its construction;

FIG. 3 is a rear plan view of the envelope of FIG. 1, with the closure flap in a closed position, arid with a portion of the rear wall of the envelope partially cut away to disclose its construction;

FIG. 4 is a front plan view of the envelope of FIG. 1, with the closure flap in an open position, and with a portion of the front wall of the envelope partially cut away to disclose its construction;

FIG. 5 is a partial cross-sectional cut-away view of the envelope of FIG. 2, taken along lines 5-5 of FIG. 2;

FIG. 6 is a schematic cross-sectional view of a multilayer laminate useful as a front or rear wall of the envelope;

FIG. 7 is a schematic cross-sectional view of another multilayer laminate useful as a front or rear wall of the envelope; and

FIG. 8 is a perspective view of an alternative envelope in an open position, with an alternative closure mechanism.

Definitions

“Air cellular material” herein refers to bubble cushioning material, such as BUBBLE WRAP® air cushioning material sold by Sealed Air Corporation, where one film or laminate is thermoformed, embossed, calendared, or otherwise processed to define a plurality of cavities, and another film is adhered to the “open” side of the thermoformed or other-wise processed film or laminate in order to close the cavities. Air cellular material typically utilizes two films which are laminated together. Usually, only one of the films is embossed, i.e., thermoformed in a manner to provide a plurality of protrusions when viewed from one side of the film, the protrusions being cavities when viewed from the other side of the film. Generally, these protrusions are regularly spaced and have a cylindrical shape, with a round base and a domed top. The formed film is generally laminated to a flat film in order to form the air cellular product. In another version, two formed films are laminated to one another to form the cellular product. Conventional methods of making such material involves the use of a vacuum source to deform polymer film to form bubbles or pockets that can be filled with air (or other gases) to form bubbles. Such materials can be made using a heated drum having recesses that are connected to a vacuum source. When vacuum is applied, each of various regions of the heated film in contact with the drum is drawn into respective recesses on the drum. The heated film is deformed and thinned in the regions drawn into the recess by the vacuum process. One portion of the resulting film remains “flat”, while another portion is not flat, but rather is “thermoformed”. A second film, which preferably is a flat film, i.e., not thermoformed, is fused to the flat portion of the formed film, resulting in a plurality of sealed, air-filled “bubbles.” Alternatives such as laminating two films together, and then inflating the interior of the two sheets to form a plurality of inflated cells, is also within the scope of “air cellular material” as used herein. Other alternatives within this definition are shown in U.S. Pat. No. 3,660,189 (Troy), U.S. Pat. Nos. 4,576,669 and 4,579,516 (Caputo), U.S. Pat. No. 4,415,398 (Ottaviano), U.S. Pat. Nos. 3,142,599, 3,508,992, 3,208,898, 3,285,793, and 3,616,155 (Chavannes), U.S. Pat. No. 3,586,565 (Fielding), U.S. Pat. No. 4,181,548 (Weingarten), and U.S. Pat. No. 4,184,904 (Gaffney), all of which are incorporated herein by reference in their entirety. It is known to prepare laminated inflatable articles which can be shipped to a converter uninflated, and inflated immediately before use. Such inflatable articles are typically made from two heat sealable films which are fused together in discrete areas to form one or more inflatable chambers. Alternatively, conventional air cellular material fabricating processes can include a first stage film fabrication step and a separate second stage fusing step. In the first stage, polymer films are fabricated by conventional techniques known to those in the art of polymer film fabrication. In the second stage, the polymer films are combined according to heat sealing methods that are known to those in the art of polymer film sealing techniques. In yet another alternative, plastic webs constitute a plurality of transparent thermoplastic laminae joined face to face and formed so that the laminae mutually define a multiplicity of pockets which are filled with gas. “Air cellular material” herein specifically excludes foamed materials.

As an alternative to air cellular materials, the present invention contemplates the use of foamed materials, such as polyolefin foams, particularly polyethylene foams. Methods for manufacturing such foams are well known in the art, as disclosed in e.g., U.S. Pat. No. 5,348,984 (Lee), U.S. Pat. No. 5,462,974 (Lee), and U.S. Pat. No. 5,667,728 (Lee), all of which are incorporated herein by reference in their entirety. One of the most common polyethylenes used is low density polyethylene (LDPE). Preferably, foams in accordance with the present invention have a density ranging from about 0.5 to about 15 pounds/ft³. The foam may be in the form of a sheet or plank having a thickness ranging from about 0.015 to about 5 inches. In producing the foam sheets, any conventional chemical or physical blowing agents may be used. Preferably, the blowing agent is a physical blowing agent such as carbon dioxide, ethane, propane, n-butane, isobutane, pentane, hexane, butadiene, acetone, methylene chloride, any of the chlorofluorocarbons, hydrochlorofluorocarbons, or hydrofluorocarbons, as well as mixtures of the foregoing. If desired or necessary, various additives may also be included with the polymer. For example, it may be desirable to include a nucleating agent (e.g., zinc oxide, zirconium oxide, silica, talc, etc.) and/or an aging modifier (e.g., a fatty acid ester, a fatty acid amide, a hydroxyl amide, etc.). Other additives that may be included if desired are pigments, colorants, fillers, antioxidants, flame retardants, stabilizers, fragrances, odor masking agents, and the like. Foam is preferably made by an extrusion process that is well known in the art. In such a process, the polymer, e.g., LDPE, is added to an extruder, preferably in the form of resin pellets. Any conventional type of extruder may be used, e.g., single screw, double screw, and/or tandem extruders. In the extruder, the resin pellets are melted and mixed. A blowing agent is preferably added to the melted polymer via one or more injection ports in the extruder. Any additives that are used may be added to the melted polymer in the extruder and/or may be added with the resin pellets. The extruder pushes the entire melt mixture (melted polymer, blowing agent, and any additives) through a die at the end of the extruder and into a region of reduced temperature and pressure (relative to the temperature and pressure within the extruder). Typically, the region of reduced temperature and pressure is the ambient atmosphere. The sudden reduction in pressure causes the blowing agent to nucleate and expand into a plurality of cells that solidify upon cooling of the polymer mass (due to the reduction in temperature), thereby trapping the blowing agent within the cells. Foamed material can be adhered to the multilayer film web of the invention by any suitable process, including heat lamination, the use of adhesive, or the like. Preferred foamed material has at least 70% closed cells, as a percent of the overall cells of the material. More preferred are at least 80%, such as at least 90% closed cells.

“Ethylene homopolymer or copolymer” herein refers to ethylene homopolymer such as low density polyethylene; ethylene/alpha olefin copolymer such as those defined hereinbelow; and other ethylene copolymers such as ethylene/vinyl acetate copolymer; ethylene/alkyl acrylate copolymer; ethylene/(meth)acrylic acid copolymer; or ionomer resin.

“Ethylene/alpha-olefin copolymer” (EAO) herein refers to copolymers of ethylene with one or more comonomers selected from C₄ to C₁₀ alpha-olefins such as butene-1,hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ or ATTANE™ resins supplied by Dow, ESCORENE™ or EXCEED™ resins supplied by Exxon; as well as linear homogeneous ethylene/alpha olefin copolymers (HEAO) such as TAFMER™ resins supplied by Mitsui Petrochemical Corporation, EXAC™ resins supplied by Exxon, or long chain branched (HEAO) AFFINITY™ resins supplied by the Dow Chemical Company, or ENGAGE™ resins supplied by DuPont Dow Elastomers.

“High density polyethylene” (HDPE) herein refers to a polyethylene having a density of between 0.94 and 0.965 grams per cubic centimeter.

“Intermediate” herein refers to a layer of a multi-layer film which is between an outer layer and an inner layer of the film.

“Inner layer” herein refers to a layer which is not an outer or surface layer, and is typically a central or core layer of a film.

“Linear low density polyethylene” (LLDPE) herein refers to polyethylene having a density between 0.917 and 0.925 grams per cubic centimeter.

“Linear medium density polyethylene” (LMDPE) herein refers to polyethylene having a density between 0.926 grams per cubic centimeter and 0.939 grams per cubic centimeter.

“Outer layer” herein refers to what is typically an outermost, usually surface layer or skin layer of a multi-layer film, although additional layers, coatings, and/or films can be adhered to it.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. “Polyamide” specifically includes those aliphatic polyamides or copolyamides commonly referred to as e.g. polyamide 6 (homopolymer based on ε-caprolactam), polyamide 69 (homopolycondensate based on hexamethylene diamine and azelaic acid), polyamide 610 (homopolycondensate based on hexamethylene diamine and sebacic acid), polyamide 612 (homopolycondensate based on hexamethylene diamine and dodecandioic acid), polyamide 11 (homopolymer based on 11-aminoundecanoic acid), polyamide 12 (homopolymer based on ω-aminododecanoic acid or on laurolactam), polyamide 6/12 (polyamide copolymer based on ε-caprolactam and laurolactam), polyamide 6/66 (polyamide copolymer based on ε-caprolactam and hexamethylenediamine and adipic acid), polyamide 66/610 (polyamide copolymers based on hexamethylenediamine, adipic acid and sebacic acid), modifications thereof and blends thereof. Said term also includes crystalline or partially crystalline, aromatic or partially aromatic, polyamides.

“Polyester” herein refers to a thermoplastic polymer in which the main polymer backbones are formed by the esterification condensation of polyfunctional alcohols and acids. Copolyesters are included. An example of a polyester is polyethylene terephthalate.

“Polymer” herein refers to homopolymer, copolymer, terpolymer, etc. “Copolymer” herein includes copolymer, terpolymer, etc.

“Propylene polymer or copolymer” herein refers to polypropylene, as well as to copolymers of propylene and ethylene, butene, etc. Examples of a copolymer of propylene are propylene/ethylene copolymer (such as propylene/ethylene random copolymer), propylene butene copolymer, and ethylene propylene butene terpolymer. As used herein, the term “polypropylene” refers to any polymer comprising propylene polymerization units, regardless of whether the polymer is a homopolymer or a copolymer. Terpolymers are also included herein.

All compositional percentages used herein are presented on a “by weight” basis, unless designated otherwise.

### DETAILED DESCRIPTION OF THE INVENTION

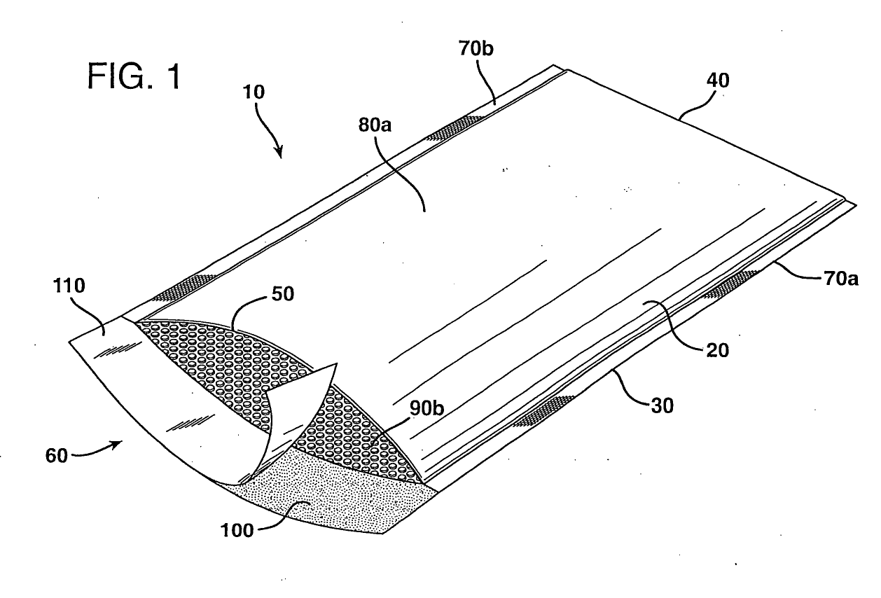

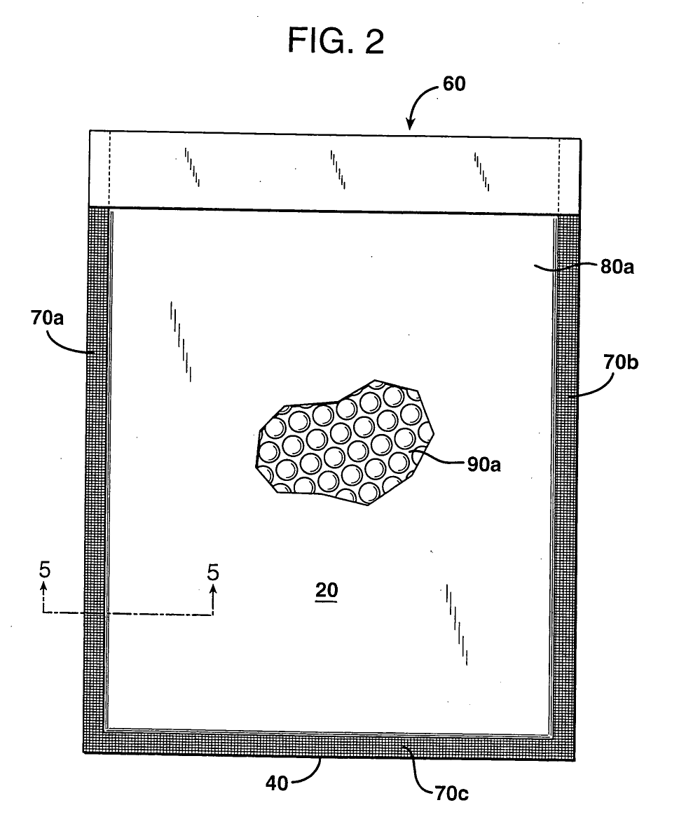

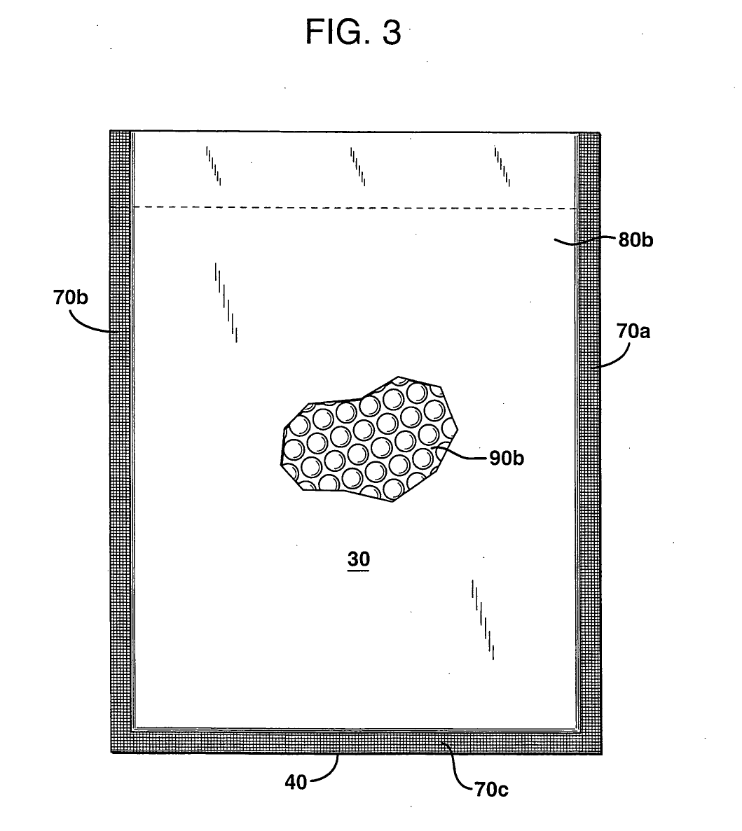

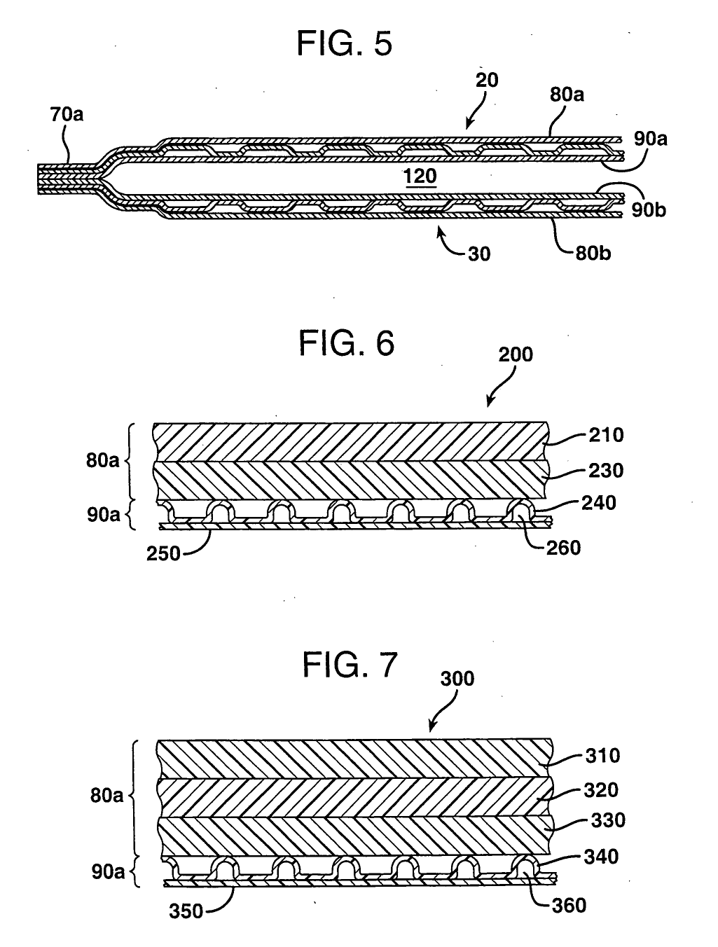

FIG. 1 is a perspective view of an envelope of the invention, and including a closure flap in an open position. The envelope 10 includes a front wall 20, a rear wall 30 (best seen in FIG. 3), a bottom 40, a mouth 50, and a closure flap 60. The envelope can be constructed by making or providing two webs of material, the composition of which is described in more detail below, and adhering these together along their edges to form the envelope. One method of adhesion is heat sealing. Thus, the front wall 20 and rear wall 30 of envelope 10 of FIG. 1 are sealed together at first lateral seal 70a, second lateral seal 70b, and bottom seal 70c (best seen in FIGS. 2, 3, and 4). A mouth 50 of the envelope is thus formed, providing access to the interior 120 (see FIG. 5) of the envelope.

An alternative construction is the manufacture or provision of a single web of material that is folded on itself, and then sealed along its two lateral edges. In this alternative embodiment, the bottom 40 of the envelope, instead of being formed as a heat seal 70c, is simply the fold in the original web. This latter embodiment is shown in FIG. 1.

The general method of construction of either embodiment will thus be well known to those of skill in the art of envelope manufacture after a review of this specification.

The closure flap 60 is formed either integrally as an extension of rear wall 30, or is a discrete member that is separately made and then adhered, e.g. by a suitable adhesive, heat sealing, radio frequency sealing, ultrasonic sealing, etc., to the upper portion of rear wall 30. If the closure flap 60 is formed as an integral part of rear wall 30, then in the manufacturing process, the web that forms the rear wall is made longer than the web that forms the front wall. When the two webs are connected by suitable means, such as heat sealing described above, one end of each web will be in congruent relationship, while the other end of the web forming the rear wall will extend beyond the longitudinal edge of the web forming the front wall. The formation and/or placement of closure flaps for envelopes in general is well known to those of skill in the art of envelope manufacture.

The closure flap 60 includes an adhesive layer 100, adhered directly or indirectly to the interior surface of the closure flap 60 (for one embodiment, this will be the interior surface of the extended portion of rear wall 30), as well as an optional but highly desirable release tape 110.

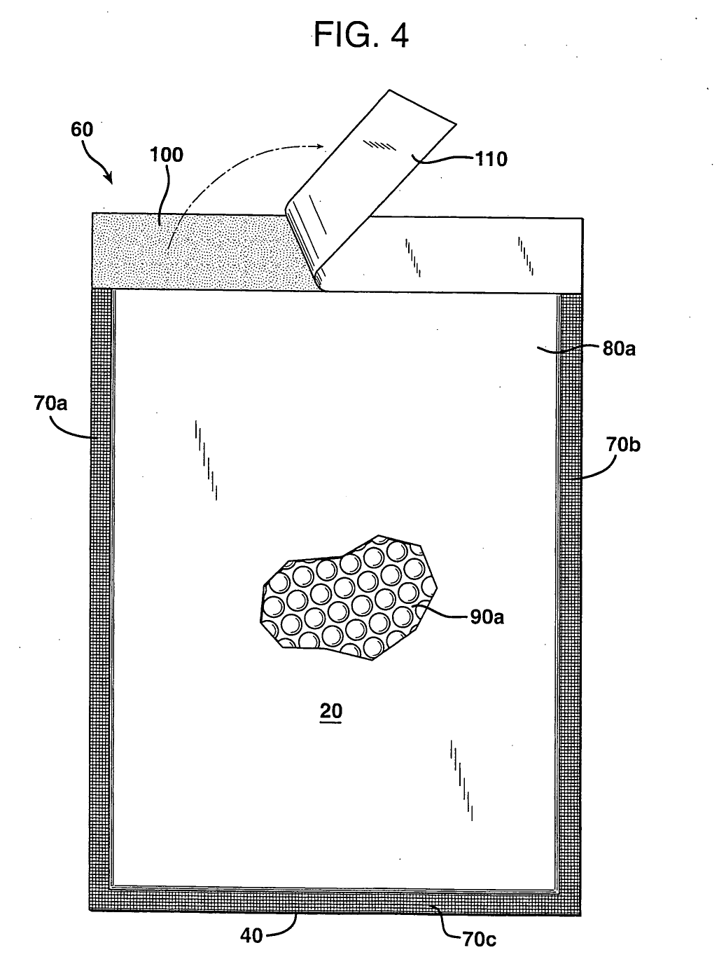

When the envelope is to be used to store or mail an article, the article is placed in the interior of the envelope, and the release tape 110 is peeled from the closure flap 60. This action exposes adhesive layer 100 (see FIG. 4). The closure flap 60, with the adhesive layer 100 thus exposed, is then folded forward towards the front wall 20 of the envelope, and the closure flap 60 is then pressed against the front wall 20 to seal the envelope. Thus, in FIG. 2, the closure flap is shown as pressed against the upper portion of the front wall 20 of the envelope to close the envelope.

The adhesive used in adhesive layer 100 is preferably a pressure sensitive adhesive, but can be any suitable adhesive, such as an adhesive activated by moisture or saliva. Suitable adhesives include thermoplastic hot melt adhesives, silicone adhesives, acrylic pressure sensitive adhesives, solvent cast adhesives, UV (ultra-violet) or EB (electron beam) cured acrylic adhesives, and the like.

Those skilled in the art will understand and be familiar with the manufacture and application of release tapes on adhesive layers or substrates, and the wide variety of commercially available adhesives for this type of application.

FIG. 5 is a partial cross-sectional cut-away view of the envelope of FIG. 2, taken along lines 5-5 of FIG. 2. It discloses the front wall 20 having a multilayer construction comprising an outer ply 80a and an inner ply 90a; and the rear wall 30 having a multilayer construction comprising an outer ply 80b and an inner ply 90b. The outer plies 80a,b form the exterior surfaces of the envelope. Plies 80a,b are themselves of multilayer construction. This is shown in FIGS. 6 and 7.

FIG. 6 is a schematic cross-sectional view of a multilayer laminate 200 useful as a front and/or rear wall of the envelope. The laminate 200 comprises an outer ply 80a and an inner ply 90a.

The outer ply 80a comprises an outer layer 210 comprising a propylene polymer or copolymer, and an inner layer 230 comprising an ethylene homopolymer or copolymer. Propylene homopolymer is preferred as the material making up layer 210 because of its strength, its ability to support a product, and its relatively high melting point. The propylene homopolymer or copolymer can optionally be blended with other polymers or copolymers different from the propylene homopolymer or copolymer, provided the propylene homopolymer or copolymer makes up at least 50% by weight of layer 210. Suitable polymers or copolymers different from the propylene homopolymer or copolymer include ethylene polymers or copolymers, regrind (i.e. scrap material resulting from the manufacture of the outer ply), and cellulosic products such as paper.

More preferably, the propylene homopolymer or copolymer makes up at least 60%, such as at least 70%, at least 80%, or at least 90%, such as at least 95%, or 100% by weight of layer 210.

Alternatively, the outer layer 210 can comprise polyamide or copolyamide, or polyester or copolyester. Any of these materials can optionally be blended with other olefin polymers or copolymers different from the polyamide or copolyamide, or polyester or copolyester, provided the polyamide or copolyamide, or polyester or copolyester makes up at least 50% by weight of layer 210. More preferably, the polyamide or copolyamide, or polyester or copolyester, makes up at least 60%, such as at least 70%, at least 80%, or at least 90%, such as at least 95%, or 100% by weight of layer 210.

The ethylene homopolymer or copolymer of inner layer 230 provides a strong bond to inner ply 90a, e.g. when heat sealed to the inner ply. The ethylenic inner layer also provides a support to enhance the tear resistance properties of the overall film. Propylene polymer and copolymer alone has only low or at best moderate tear resistance properties. The ethylene homopolymer or copolymer can optionally be blended with other olefin polymers or copolymers different from the ethylene homopolymer or copolymer, provided the ethylene homopolymer or copolymer makes up at least 50% by weight of layer 230. More preferably, the ethylene homopolymer or copolymer makes up at least 60%, such as at least 70%, at least 80%, or at least 90%, such as at least 95%, or 100% by weight of layer 230.

Film of the present invention can be made by any suitable process, such as tubular or flat cast coextrusion, hot blown extrusion, lamination, extrusion coating, or corona bonding, by techniques well known in the art, such as the process shown in U.S. Pat. No. 4,551,380 (Schoenberg), herein incorporated by reference in its entirety.

The inner ply 90a has an inner and outer surface, and comprises an air cellular or foamed material. The air cellular material can be e.g. a material such as BUBBLE WRAP ™ air cellular material sold by Sealed Air Corporation. The air cellular material will typically comprise a formed layer 240 (the “bubbles” of the air cellular material), and a substrate layer 250 which closes the formed layer to define cavities 260 within the air cellular material. Layers 240 and 250 can be made of any suitable material, especially thermoplastics, and especially olefinic polymers such as ethylene polymer or copolymer. One or both of layers 240 and 250 can optionally have a multilayer construction, including e.g. an oxygen barrier material such as polyamide, polyester, polyvinylidene dichloride, or ethylene/vinyl alcohol copolymer.

The inner surface of the outer ply 80a (i.e. the inner surface of layer 230) is adhered by any suitable means, such as heat sealing, adhesives, etc., to the outer surface of the inner ply 90a (i.e. the outer surface of layer 240).

FIG. 7 is a schematic cross-sectional view of an alternative embodiment of the invention, disclosing another multilayer laminate useful as a front and/or rear wall of the envelope. The laminate 300 comprises an outer ply 80a and an inner ply 90a. The outer ply 80a comprises an outer layer 310 comprising a propylene polymer or copolymer, and an inner layer 330 comprising an ethylene homopolymer or copolymer. Layers 310 and 330 thus correspond to and can comprise the same materials and construction as layers 210 and 230 of FIG. 6. In the alternative embodiment of FIG. 7, an intermediate layer 320 is disposed in between layers 310 and 330. Layer 320 preferably comprises an olefin polymer or copolymer, such as low density polyethylene, linear low density polyethylene or other ethylene/alpha-olefin copolymer, or propylene polymer or copolymer; polyamide or copolyamide; or polyester or copolyester; such as those described herein for layers 210 and 310.

Either or both of layers 310 and 320, or layer 210 of FIG. 6, can comprise a blend of propylene homopolymer and copolymer. Propylene homopolymer is less expensive, while propylene copolymer offers better processing. When a blend is used in any of these layers, a preferred blend ratio is between 5% and 95%, by weight of the blend, of propylene homopolymer, and between 95% and 5%, by weight of the blend, of propylene copolymer. More preferred is a blend of between 40% and 80%, by weight of the blend, of propylene homopolymer, and between 80% and 40%, by weight of the blend, of propylene copolymer. Most preferred is a blend of 60% by weight of the blend, of propylene homopolymer, and 40%, by weight of the blend, of propylene copolymer.

The inner ply 90a has an inner and outer surface, and comprises an air cellular or foamed material. The air cellular material can be e.g. a material such as BUBBLE WRAP ™ air cellular material sold by Sealed Air Corporation. The air cellular material will typically comprise a formed layer 340 (the “bubbles” of the air cellular material), and a substrate layer 350 which closes the formed layer to define cavities 360 within the air cellular material. Thus, inner ply 90a of FIG. 7 corresponds in composition and structure to inner ply 90a of FIG. 6.

The inner surface of the outer ply 80a (i.e. the inner surface of layer 330) is adhered by any suitable means to the outer surface of the inner ply 90a (i.e. the outer surface of layer 340).

For the embodiments of both FIGS. 6 and 7, the discussion herein with respect to the composition, structure, and method of manufacture of outer ply 80a and inner ply 90a applies to outer ply 80b and inner ply 90b respectively.

The outer layer of the outer ply (layer 210 or layer 310) differs in composition from the inner layer of the outer ply (layer 230 or layer 330) respectively.

Commercial examples of suitable propylene homopolymers or copolymers for layers 210 or 310 include HB 1001™ (propylene homopolymer) and TG 7001™ (propylene ethylene random copolymer), both available from BP Amoco Chemical Company.

For hot blown extrusion, preferred propylene homopolymers or copolymers include EPQ 30 RF™ available from Basell; BA 110 CF™ available from Borealis; STAMYLAN P 83 EK 10™ available from DSM; and INSPIRE 112™ available from Dow Chemical. For cast extrusion, any propylene homopolymer or copolymer with a melt flow index greater than 1 can be used. One example is MOPLEN X30S™ available from Basell.

Alternatively, layers 210 or 310 can comprise a polyamide.

Commercial examples of suitable polyamides include 1860™ nylon 6 available from Allied Signal.

Alternatively, layers 210 or 310 can comprise a polyester.

Commercial examples of suitable polyesters include 9921™ bottle grade polyester available from Eastman Chemical.

Intermediate layer 320 can comprise any of the materials of layer 310, and can be of the same or different composition from layer 320.

Commercial examples of suitable ethylene homopolymers or copolymers for layers 230 or 330 include DOWLEX 2045™, a linear low density polyethylene (ethylene/1-octene copolymer having a density of about 0.920 grams/cc), and ATTANE 4201™, a very low density polyethylene (ethylene/1-octene copolymer having a density of about 0.912 grams/cc), both available from Dow Chemical. These materials can be blended in any suitable proportion. One preferred blend is between 50% and 99%, by weight of the blend, of linear low density polyethylene, and between 1% and 50%, by weight of the blend, of very low density polyethylene. More preferably, the blend comprises between 65% and 85%, by weight of the blend, of linear low density polyethylene, and between 15% and 35%, by weight of the blend, of very low density polyethylene. A preferred blend is 75% linear low density polyethylene and 25% very low density polyethylene. FG166™ available from Polimeri Europa; ELITE™ and ATTANE™ resins available from Dow Chemical; and EXACT™ and EXCEED™ resins available from Exxon can be used.

Optionally, the outer layers 210 or 310 can include a “paper match”, i.e. typically 5% to 50%, such as 10% to 30%, by weight of the outer layer, of calcium carbonate or talc, and optionally also additional minor amounts of silica or titania, processing aids; or slip or anti-block additives of a type well known in the art. Between 10% and 30%, by weight of the outer layer, of titania can make the film more opaque. The presence of mineral additives, such as talc or calcium carbonate, can also play an important role in enhancing (increasing) the effective melting point of the film's outer layer. This can be important in improving the heat sealing performance of the film.

Optionally, reclaim from the production of outer ply 80a can be used in the middle layer 320 of the outer ply 80a of FIG. 7.

Optionally, the outer layers 210 or 310 can be printed on their outer surface, or trap printed on their inner surface.

Antistat (e.g. glycerol monostearate, ethoxylated amine, or amide) can be included in outer layers 210 or 310 in any suitable amount, preferably ranging from 0.5% to 2%, by weight of the outer layer.

The outer plies 80a and 80b can be of any suitable thickness, but preferably each ply has a thickness of between 1 mil and 6 mils, such as between 2 and 4 mils.

Seals 70a,b,c can be made by any suitable means, but preferred is heat sealing. Other means for adhering include radio frequency sealing, lamination with adhesives, corona treatment, or ultrasonic sealing.

Additional intermediate layers can be included as appropriate within the outer or inner plies. For example, an adhesive layer can be included e.g. between layer 210 and layer 230; between layer 310 and layer 320; or between layer 320 and layer 330. Preferred are polymeric adhesives, especially anhydride modified polyolefin, polyamide, or polyester. These materials include an anhydride functionality. As used herein, the phrase “anhydride functionality” refers to any form of anhydride functionality, such as the anhydride of maleic acid, fumaric acid, etc., whether blended with one or more polymers, grafted onto a polymer, or copolymerized with a polymer, and, in general, is also inclusive of derivatives of such functionalities, such as acids, esters, and metal salts derived therefrom. Examples of modified polyolefins are PLEXAR 165™, an anhydride-modified low density polyethylene available from Equistar.

### EXAMPLES

### Example 1

A five layer multilayer film web was cast coextruded through an annular die. The film had the construction A/B/C/D/E as follows:

| | | | | E |
|---|---|---|---|---|
| | | | | 30% DOWLEX |
| A | B | C | D | 4201 + 60% |
| 75% TG7001 + 25% | 90% TG7001 + 10% | 90% TG7001 + 10% | 90% TG7001 + 10% | NA963 ™ + 10% |
| CaCO₃ | TiO₂ | TiO₂ | TiO₂ | silver pigment |
| 15% | 20% | 30% | 20% | 15% |

Note:
NA963 ™ is a low density polyethylene with a melt index of 1, and a density of 0.92 grams/cm³, available from Equistar.

The percentages listed below each column indicate the percent of the total film thickness that comprises that particular layer.

In a separate operation, a second web of BUBBLE WRAP™ air cellular material was produced in a conventional manner.

The multilayer film web was laminated to the air cellular material by advancing the multilayer film web and the second web between a heated roll and a second roll, such that the outer layer (layer A) of the multilayer film web came in contact with the heated roll, one surface of the air cellular material came in contact with the second roll, and the inner layer (layer E) of the multilayer film web came in contact with and adhered to the air cellular material to form a laminate. The laminate was then cut to form a first portion and a second portion, the second portion having a length greater than the length of the first portion, each portion having two lateral edges, a top edge, and a bottom edge. The first and second portions were sealed along their respective lateral edges and bottom edge to form an envelope.

### Example 2

An envelope was made as described in Example 1, except that the five layer multilayer film web had the following construction:

| | | | | E |
|---|---|---|---|---|
| | | | | 30% DOWLEX |
| A | B | C | D | 4201 + 60% |
| 75% TG7001 + 25% | 90% HB1001 + 10% | 90% HB1001 + 10% | 90% HB1001 + 10% | NA963 ™ + 10% |
| CaCO₃ | TiO₂ | TiO₂ | TiO₂ | silver pigment |
| 15% | 20% | 30% | 20% | 15% |

### Example 3

An envelope was made as described in Example 1, except that a three layer film web had the following construction:

| A | B | C |
|---|---|---|
| 60% EPQ 30RF ™ + 20% | 90% INSPIRE 112 ™ + | 100% FG 166 |
| CaCO₃ + 20% TiO₂ | 10% TiO₂ | Super C6 ™ |
| 45 micrometers | 20 micrometers | 20 micrometers |

### Example 4

An envelope was made as described in Example 1, except that a three layer film web had the following construction:

| A | B | C |
|---|---|---|
| 60% BA 110 CF ™ + 20% | 90% BA 110 CF ™ + | 100% ATTANE |
| CaCO₃ + 20% TiO₂ | 10% TiO₂ | SL 4201 ™ |
| 45 micrometers | 15 micrometers | 25 micrometers |

Notes for Examples 3 and 4:
1. EPQ 30 RF ™ is a heterophasic copolymer having a propylene homopolymer moiety and an ethylene/propylene rubber moiety (30% by weight of the overall copolymer), commercially available from Basell.
2. BA 110 CF ™ is an equivalent to EPQ 30 RF ™, and available from Borealis.
3. INSPIRE 112 ™ is a high melt strength propylene homopolymer from Dow.
4. The CaCO₃ of the outer “A” layer was a masterbatch of 70% CaCO₃ and 30% polypropylene, commercially available as MP53663 ™ from Polyone.
5. The TiO₂ of the outer “A” layer and the intermediate “B” layer was a masterbatch of 50% TiO₂ and 50% polypropylene.
6. The total thickness of the film was 85 micrometers.
7. The ATTANE SL 4201 of the “C” layer of Example 4 is a very low density polyethylene available from Dow Chemical, and is an ethylene/1-octene copolymer with a density of 0.905 grams/cubic centimeter.

### Example 5

An envelope is made as described in Example 1, except that a four layer film web has the following construction:

| A | | C | D |
|---|---|---|---|
| 80% propylene | B | 100% | 100% |
| homopolymer + | 100% propylene | ATTANE SL | ATTANE SL |
| 20% CaCO₃ | homopolymer | 4201 ™ | 4201 ™ |
| 25% | 25% | 25% | 25% |

### Example 6

An envelope is made as described in Example 1, except that a four layer film web has the following construction:

| A | B 100% | C 100% | D 100% |
|---|---|---|---|
| 80% polyamide + | anhydride modified | propylene | ATTANE SL |
| 20% CaCO₃ | polymeric adhesive | homopolymer | 4201 ™ |
| 25% | 25% | 25% | 25% |

### Examples 7 to 12

Multilayer film webs like those of examples 1 to 6 respectively are made, and an envelope is made from each web, except that the laminate is cut to form a first portion and a second portion of equal length.

### Examples 13 to 18

Multilayer film webs like those of examples 1 to 6 respectively are made, and an envelope is made from each web, except that the laminate, instead of being cut, is folded to form a first portion and a second portion, the second portion having a length greater than the length of the first portion.

### Examples 19 to 24

Multilayer film webs like those of examples 1 to 6 respectively are made, and an envelope is made from each web, except that the laminate, instead of being cut, is folded to form a first portion and a second portion of equal length.

### Examples 25 to 48

Multilayer film webs like those of examples 1 to 24 respectively are made, and an envelope is made from each web, except that instead of an air cellular material, a foamed material is used.

Those skilled in the art will understand that modifications in the invention can be made without departing from the scope of the invention as claimed in the claims that follow.

For example, although specific embodiments have been disclosed herein, any suitable number of layers can be used to construct the outer ply 80a or 80b of the envelope of the invention.

One or more layers of the outer ply can include a pigment.

Although the preferred embodiments as disclosed include a closure flap, several alternative embodiments can be made.

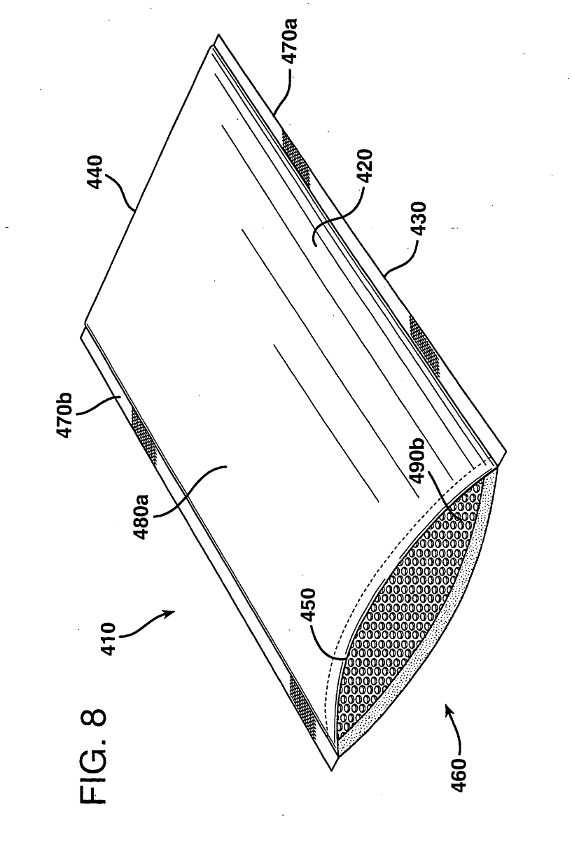

For example, one alternative embodiment is illustrated in FIG. 8. FIG. 8 is a perspective view of an envelope in an open position, with an alternative closure mechanism. The envelope 410 includes a front wall 420, a rear wall 430, a bottom 440, and a mouth 450. The envelope can be constructed by any of the processes disclosed herein. The front and rear walls of the envelope are substantially congruent and of substantially the same size and length. The side edges of the envelope are sealed at side seals 470a and 470b. The alternative closure mechanism is simply a heat seal or a sealing tape 460. Sealing tapes are conventionally used in providing a closing mechanism for envelopes of various designs. Typically, a pressure sensitive adhesive is applied to the upper portion of the interior side of one of the first or second walls of an envelope. Usually, a release tape covers the adhesive to avoid premature closure of the envelope. Thus, the alternative closure mechanism of FIG. 8 is in one embodiment similar in construction and function to the adhesive layer 100 and release tape 110 of FIG. 1, except that no extended flap is necessary. The adhesive portion of alternative closure mechanism 460 can be installed directly on the upper inner surface of the front wall 420 or back wall 430 of the envelope, or can be attached as a discrete tape, by adhesive or heat sealing or the like, to tached as a discrete tape, by adhesive or heat sealing or the like, to the upper inner surface of the front or back wall. In such an embodiment, the extended closure flap described elsewhere herein is not needed. The walls of the envelope in this alternative embodiment can thus be closed at their respective top edges. The methodology for making such an envelope is similar to that described above, except that the laminate will be cut and folded as disclosed to provide front and rear walls of substantially the same length and width.

In lieu of any adhesive or other closure, a heat seal or other mechanism, such as RF or ultrasonic sealing, can be used to close the envelope.

It will be noted in FIG. 8 that a small portion of the back wall 430, at the top edge thereof, is preferably devoid of the air cellular material of inner ply 490b in order to accommodate the closure 460. Likewise, a corresponding upper section of the front wall 420 is preferably devoid of the air cellular material in order to accommodate and provide a surface to which the adhesive of closure 460 can adhere when closing the envelope. Heat seals will similarly be facilitated by such a construction. Of course, the adhesive can be initially positioned on the upper inner surface of front wall 420 instead.

Other closure mechanisms can be suitably selected as appropriate along the upper portions of the envelope, including zipper-type or other mechanical closing systems.

The envelope in some applications may not require closure at all. In such an embodiment, the envelope will be constructed as shown in FIG. 8, but without closure mechanism 460.

Thus, closure systems are optional, although usually desirable.

Although the invention has been described, in the disclosure including the examples, primarily with respect to the use of air cellular material as the inner ply of the walls of the envelope, a foamed material can be used mutatis mutandis instead of the air cellular material as the inner ply.

What is claimed is:

1. An envelope comprising:
a) a front wall having two lateral edges, a top edge, and a bottom edge; and
b) a rear wall having two lateral edges, a top edge, and a bottom edge, the front and rear walls joined along their respective lateral and bottom edges;
the front and rear walls each comprising
i) an outer ply comprising
(a) an outer layer comprising a polymer selected from the group consisting of propylene polymer or copolymer, polyamide or copolyamide, and polyester or copolyester; and
(b) an inner layer comprising ethylene homopolymer or copolymer,
wherein the outer ply has an outer surface and an inner surface; and
ii) an inner ply having an inner surface and an outer surface, comprising an air cellular or foamed material;
the inner surface of the outer ply being adhered to the outer surface of the inner ply.

2. The envelope of claim 1 wherein the two lateral edges of the front wall are joined to the two lateral edges of the rear wall by heat seals.

3. The envelope of claim 1 wherein the bottom edge of the front wall is joined to the bottom edge of the rear wall by a heat seal.

4. The envelope of claim 1 wherein the bottom edge of the front wall is joined to the bottom edge of the rear wall by a fold.

5. The envelope of claim 1 wherein the envelope comprises a closure flap extending from the rear wall of the envelope.

6. The envelope of claim 1 wherein the front wall and rear wall are of substantially equal length, and the front and rear wall are adapted to be closed by means of an adhesive disposed near the top edge of the front or rear wall.

7. The envelope of claim 1 wherein the front wall and rear wall are of substantially equal length, and the front and rear wall are adapted to be closed by means for heat sealing.

8. The envelope of claim 1 wherein the outer layer of the outer ply comprises calcium carbonate.

9. The envelope of claim 1 wherein the outer ply comprises an intermediate layer, disposed between the outer layer and inner layer, comprising a polymer selected from the group consisting of olefin polymer or copolymer, polyamide or copolyamide, and polyester or copolyester.

10. The envelope of claim 1 wherein the outer layer of the outer ply comprises a blend of between 50% and 95%, by weight of the outer layer, of a polymer selected from the group consisting of propylene polymer or copolymer, polyamide or copolyamide, and polyester or copolyester, and between 5% and 50%, by weight of the outer layer, of an polymer or copolymer different from the propylene polymer or copolymer, polyamide or copolyamide, or polyester or copolyester.

11. The envelope of claim 1 wherein the inner layer of the outer ply comprises a blend of between 50% and 95%, by weight of the inner layer, of a polymer selected from the group consisting of ethylene homopolymer or copolymer, and between 5% and 50%, by weight of the inner layer, of an olefin polymer or copolymer different from the ethylene homopolymer or copolymer.

12. The envelope of claim 1 wherein the closure flap comprises an adhesive disposed on one side of the flap.

13. The envelope of claim 1 wherein the air cellular material comprises a formed layer, and a substrate layer which functions to close the formed layer to define cavities within the air cellular material.

14. A method of making an envelope comprising:
a) providing a multilayer film web comprising
i) an outer layer comprising a polymer selected from the group consisting of propylene polymer or copolymer, polyamide or copolyamide, and polyester or copolyester, and
ii) an inner layer comprising an ethylene homopolymer or copolymer;
b) providing a second web comprising an air cellular or foamed material;
c) advancing the multilayer film web and the second web between a heated roll and a second roll, such that
i) the outer layer of the multilayer film web comes in contact with the heated roll,
ii) one surface of the second web comes in contact with the second roll, and
iii) the inner layer of the multilayer film web comes in contact with and adheres to the second web to form a laminate;
d) cutting the laminate to form a first portion and a second portion, each portion having two lateral edges, a top edge, and a bottom edge; and
e) sealing the first and second portions along their respective lateral edges and bottom edges to form the envelope.

15. The method of claim 14 wherein the two lateral edges of the first portion are joined to the two lateral edges of the second portion by heat seals.

16. The method of claim 14 wherein the second portion has a length greater than the length of the first portion, such that a closure flap is formed that is integral with the second portion of the cut laminate.

17. The method of claim 14 wherein the second portion has a length substantially the same as the length of the first portion, and one of the first and second portions has a sealing tape disposed thereon, the sealing tape adapted to close the envelope.

18. The method of claim 14 wherein the second portion has a length substantially the same as the length of the first portion, and the first and second portions are adapted to be closed by heat sealing.

19. The method of claim 14 wherein the multilayer film web comprises an intermediate layer, disposed between the outer layer and inner layer, comprising a polymer selected from the group consisting of olefin polymer or copolymer, polyamide or copolyamide, and polyester or copolyester.

20. A method of making an envelope comprising:
a) providing a multilayer film web comprising
i) an outer layer comprising a polymer selected from the group consisting of propylene polymer or copolymer, polyamide or copolyamide, and polyester or copolyester, and
ii) an inner layer comprising an ethylene homopolymer or copolymer;
b) providing a second web comprising an air cellular or foamed material;
c) advancing the multilayer film web and the second web between a heated roll and a second roll, such that
i) the outer layer of the multilayer film web comes in contact with the heated roll,
ii) one surface of the second web comes in contact with the second roll, and
iii) the inner layer of the multilayer film web comes in contact with and adheres to the second web to form a laminate;
d) folding the laminate to form a first portion and a second portion, each portion having two lateral edges; and
e) sealing the first and second portions along their respective lateral edges to form the envelope.

21. The method of claim 20 wherein the second portion has a length greater than the length of the first portion, such that a closure flap is formed that is integral with the second portion of the folded laminate.

22. The method of claim 20 wherein the second portion has a length substantially the same as the length of the first portion, and one of the first and second portions has a sealing tape disposed thereon, the sealing tape adapted to close the envelope.

23. The method of claim 20 wherein the second portion has a length substantially the same as the length of the first portion, and the first and second portions are adapted to be closed by heat sealing.
